(19) United States
(12) Patent Application Publication
(10) Pub. No.: US 2024/0408524 A1
(43) Pub. Date: Dec. 12, 2024

(54) FILTER APPARATUS

(71) Applicant: RZ Industries LLC, Burnsville, MN (US)

(72) Inventor: Steve Gordon Torbenson, Lakeville, MN (US)

(21) Appl. No.: 18/699,235

(22) PCT Filed: Oct. 6, 2022
(86) PCT No.: PCT/US22/45920

§ 371 Date: Apr. 5, 2024

Related U.S. Application Data
(60) Provisional application No. 63/252,968, filed on Oct. 6, 2021.
(60) Provisional application No. 63/282,452, filed on Nov. 23, 2021.

(51) Int. Cl. B01D 46/00; B01D 46/62

(52) U.S. Cl. CPC B01D 46/0005; B01D 46/0004; B01D 46/62; B01D 2265/024; B01D 2271/02; B01D 2279/50

(57) ABSTRACT

Aspects of the present disclosure are directed to air filtering components and related methods. As may be implemented in accordance with one or more embodiments, an apparatus includes a filter frame having an outer perimeter and configured to hold at least one filter within the outer perimeter, and a fastener configured to selectively couple and decouple the filter frame to an air passageway of an air movement component. The fastener is further configured with the filter frame to seal the outer perimeter around an opening in the air passageway via which air may flow by engaging with the air passageway and applying a force to the filter frame in a direction toward the air movement component, therein forming a sealed air flow channel through the filter frame and the at least one filter held within the outer perimeter.

### BACKGROUND

Aspects of the present disclosure are applicable to filter apparatuses and their implementation.

Various environments exhibit undesirable air conditions, as may relate to particulates, odors, gas, vapors and/or airborne pathogens. For instance, public spaces such as hotel rooms, hospital rooms, apartments, senior living homes and others may be subjected to such conditions. Existing air movement equipment, which may include heating, ventilating and air conditioning (HVAC) type equipment, may provide inadequate filtering capabilities.

### SUMMARY

Various example embodiments are directed to filter apparatuses, their application and their manufacture. Such embodiments may be useful for coupling to existing HVAC type equipment, such as wall or window equipment, portable equipment, and such equipment as may be used in residential environments such as hotels, apartments and homes. Further, such aspects are directed to collapsible filter apparatuses that are amenable to transportation and application to a variety of different HVAC units, for example as my be utilized by travelers who may stay in various residential environments. In such conditions, embodiments characterized herein may be utilized to provide portable enhanced filtration by coupling to multiple different types of HVAC equipment.

Accordingly, various example embodiments are directed to a filter apparatus and its use, which may address such challenges as noted above. Specific embodiments are directed to a filter frame and related filter media configured to couple to HVAC type equipment for filtering air exchanged therewith. Certain such embodiments involve a filter frame that couples to wall or window-type HVAC equipment, for instance to seal to and filter air expelled from wall HVAC units utilized in hotel rooms, hotels, apartments or other environments.

In accordance with a particular embodiment, an apparatus includes a filter frame having an outer perimeter and configured to hold at least one filter within the outer perimeter, and a fastener configured to selectively couple and decouple the filter frame to an air passageway of an air movement component. The fastener is configured to seal the outer perimeter around an opening in the air passageway via which air may flow by engaging with the air passageway to apply a force to the filter frame in a direction toward the air movement component, therein forming a sealed air flow channel through the filter frame and the at least one filter held within the outer perimeter.

Another embodiment is directed to filtering air flowing into and/or out of an air movement component via an air passageway. An apparatus including a filter frame with an outer perimeter is sealed around an opening in the air passageway via which air may flow by engaging a fastener with the air passageway to apply a force to the filter frame in a direction toward the air movement component. A sealed air flow channel is thus formed through the filter frame and at least one filter held within the outer perimeter of the filter frame. The fastener may be used to selectively couple and decouple the filter frame to the air passageway.

The above discussion is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description and in connection with the accompanying drawings, in which:

FIG. 1 is a front lower left perspective view of a filter apparatus, in accordance with one or more embodiments;

FIG. 2 is a front lower right perspective view of the filter apparatus in FIG. 1;

FIG. 3 is a front upper left perspective view of the filter apparatus in FIG. 1;

FIG. 4 is a front upper right perspective view of the filter apparatus in FIG. 1;

FIG. 5 is a rear lower left perspective view of a filter apparatus, showing the present design;

FIG. 6 is a rear lower right perspective view of the filter apparatus in FIG. 1;

FIG. 7 is a rear upper left perspective view of the filter apparatus in FIG. 1;

FIG. 8 is a rear upper right perspective view of the filter apparatus in FIG. 1;

FIG. 9 is a front view of the filter apparatus in FIG. 1;

FIG. 10 is a left side view of the filter apparatus in FIG. 1;

FIG. 11 is a right side view of the filter apparatus in FIG. 1;

FIG. 12 is a top view of the filter apparatus in FIG. 1;

FIG. 13 is a bottom view of the filter apparatus in FIG. 1;

FIG. 14 is a rear view of the filter apparatus in FIG. 1;

FIG. 15 is an exploded top view, as may be implemented with the filter apparatus of FIG. 1;

FIG. 16 is an exploded bottom view, as may be implemented with the filter apparatus of FIG. 1;

FIG. 17 shows a front perspective view of a portion of the filter apparatus of FIG. 1;

FIG. 18 shows a rear perspective view of a portion of the filter apparatus of FIG. 1;

FIG. 19 shows an exploded view of a portion of the filter apparatus of FIG. 1 and filters that may be used therewith, in accordance with one or more embodiments;

FIG. 20 shows a perspective view of an implementation of a fastener, as may be utilized with the filter apparatus of FIG. 1;

FIG. 21 shows engagement componentry for coupling respective portions of a filter apparatus, such as may be implemented with the filter apparatus of FIG. 1;

FIG. 22 shows additional engagement componentry for coupling respective portions of a filter apparatus, such as may be implemented with the filter apparatus of FIG. 1;

FIG. 23 shows a perspective view of an implementation of a fastener coupled to a filter apparatus, as may be utilized with the filter apparatus of FIG. 1;

FIG. 24 shows a perspective view of an implementation of a filter apparatus, such as that depicted in FIG. 1, coupled to an HVAC unit in accordance with one or more embodiments;

FIGS. 25-27 respectively show top/front, underside/rear and exploded views of an apparatus, operable as a replacement cover and/or an over-cover for an HVAC unit, as may be implemented in accordance with one or more embodiments;

FIG. 28 shows an apparatus including a cover having a filter component, as may be implemented in accordance with one or more embodiments herein; and

FIG. 29 shows an HVAC filter apparatus 290, in accordance with another embodiment.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as may be used throughout this application is by way of illustration, and not limitation.

### DETAILED DESCRIPTION

Aspects of the present disclosure are believed to be applicable to a variety of different types of articles of manufacture, apparatuses, systems and methods involving filter apparatuses. In certain implementations, aspects of the present disclosure have been shown to be beneficial when used in the context of a filter apparatus for coupling to existing air movement equipment for adding filtration capabilities. Particular embodiments are directed to a filter apparatus having a frame and related componentry that may be coupled to an in-wall HVAC unit, with filter material held by the frame and operable to filter air provide from and/or to the HVAC unit. While not necessarily so limited, various aspects may be appreciated through a discussion of examples using such exemplary contexts.

According to various example embodiments, an apparatus includes a filter and a filter frame configured to hold the filter, the frame having a fastener to couple the filter frame to an air inlet and/or outlet of an air movement component, with an outer portion of the frame configured to seal around the inlet and/or outlet. The frame is configured and arranged with the filter to form an air flow channel sealed around the inlet and/or outlet of the air movement component, and to filter air flowing through the air flow channel, therein filtering are moving into our out of the air movement component.

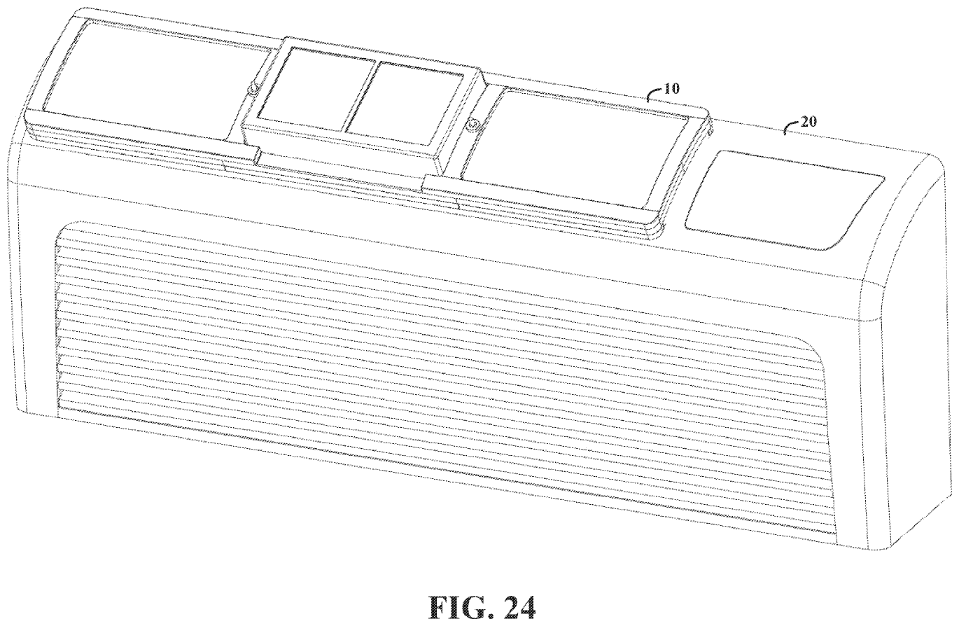

The filter frame may be configured with the filter, for utilization by filtering air within an enclosed environment. The filter frame and filter may be coupled to an HVAC unit that feeds air into the environment. In some implementations, an air flow channel around an air outlet of such an HVAC unit is sealed such that air expelled by the HVAC unit is filtered via the sealed air flow channel. For instance, FIG. 24 as described below shows such an application.

In some embodiments, the apparatus noted above and/or another apparatus includes a filter and filter frame integrated into a replacement cover for HVAC equipment, such as to replace an existing cover for improved filtration, repair or otherwise. In certain embodiments, the apparatus noted above and/or another apparatus includes a filter and filter frame integrated into a cover to cover an entire exterior surface of HVAC equipment, such as to form onto an existing cover for improved filtration, cover damage, improve looks, or otherwise. In such embodiments, adapters or spacers may be present on an interior portion of the apparatus for accommodating different applications. Further, such apparatuses may include lateral adjustability, for instance slides that allow the apparatus to be extended in width while maintaining coverage of an underlying HVAC apparatus.

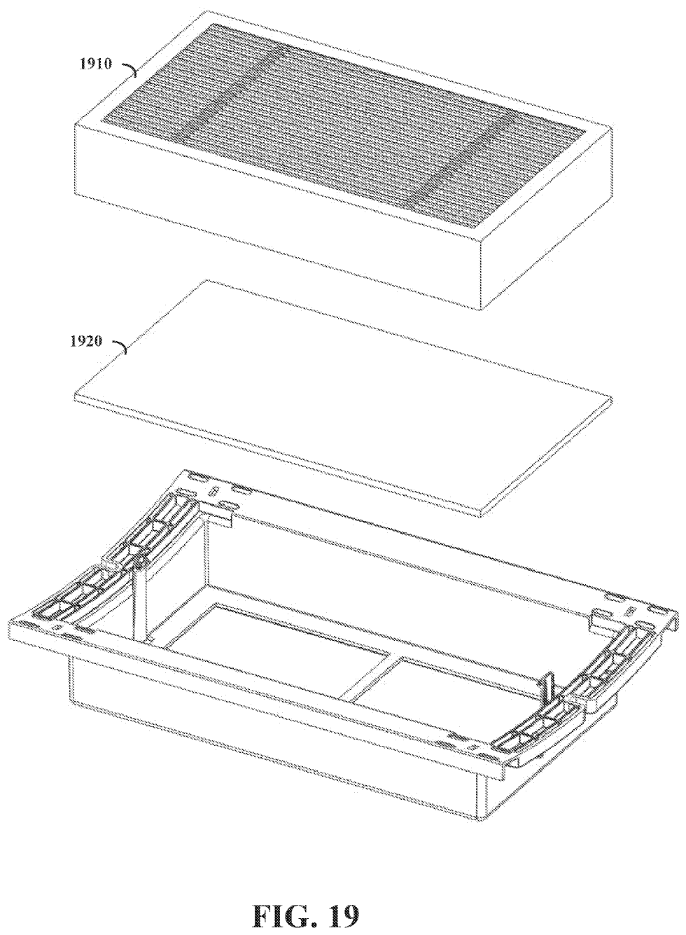

Various embodiments are directed to implementation with aspects of the disclosure in the underlying U.S. Provisional Patent Application (including the Appendix section therein), having Ser. No. 63/282,452 and filed on Oct. 6, 2021, which depicts filter apparatuses and which is fully incorporated herein by reference. For instance, the filter apparatus in the Appendix may be implemented using one or more aspects of the embodiments shown in the figures. Similarly, the embodiments shown in the figures may be implemented in accordance with the various assembly components/methods as depicted in the Appendix. For instance, the frame components show in the figures may be implemented with one or more of filter hooks and side locks as shown. In addition, the fastener(s) characterized herein may utilize a negative rake as shown, crimp to retain knob and overall knob/threaded shaft componentry as also shown. Retention tabs may be utilized for HEPA and/or active carbon (AC) filters, for instance in connection with FIG. 19 as described below. Similarly, the frame assembly steps may be utilized with the frame components and filters as noted in one or more drawings.

Various types of filter material may be used. For instance, active carbon panels may be utilized on the left and right side, which may facilitate reduction of odors and fumes. Other filter media may be used on the left and right side, for instance to provide enhanced particular filtering, as may utilize filter media/nanofiber technology. For instance, in a low dust and particulate environment, an active carbon filter may be used to eliminate odors, smoke & fumes. In a high dust and particulate environment where odors may not be a concern, filters tailored for particulate filtering may be used. Such filters may, for example, be interchangeable. In other embodiments, a combination of filters is used to suit these and/or other filtering operations. In still other embodiments, filters having multiple types of filtration material is used (e.g., both active carbon and microfiber, or a filter material exhibiting both active carbon and microfiber). In still other embodiments, different types of filters are used for intake and exhaust vents, for instance by coupling the claimed apparatus to HVAC equipment such that a fiber-based particulate filter is aligned to one of intake and exhaust ports, and an active carbon filter is aligned to the other one of the intake and exhaust ports.

In some implementations, an elastic type material may be used to enhance sealing of the filter apparatus to HVAC equipment. For instance, memory foam may be utilized along the edges of the apparatus on the backside, as may be integrated with or coupled to a frame, for engaging with HVAC equipment.

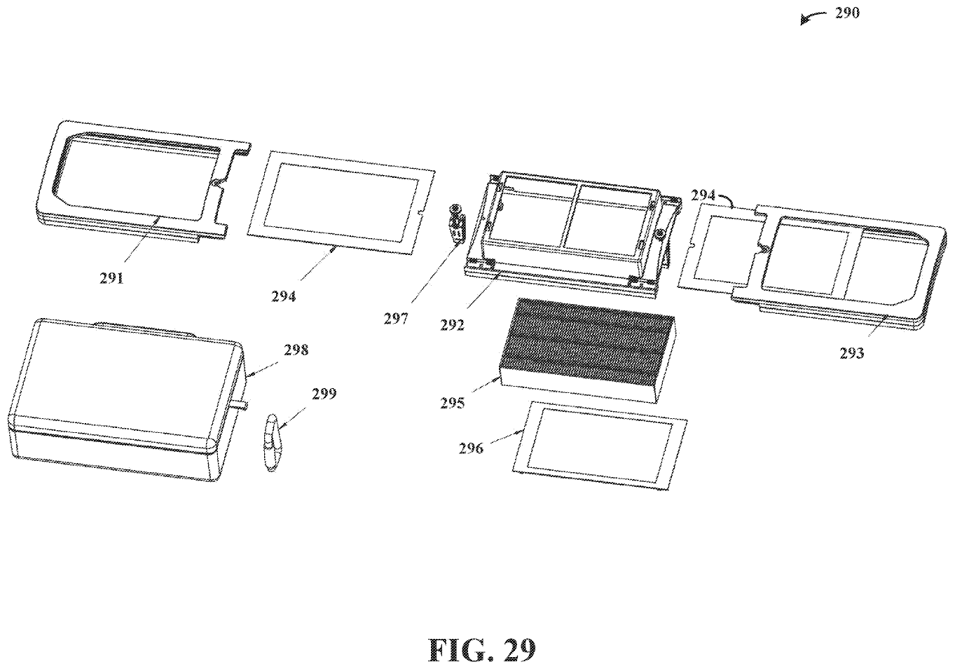

Certain embodiments are directed to an assembly kit filter apparatus, which includes multiple components that may be assembled and disassembled for travel, and for coupling to various different HVAC equipment in different locations. FIG. 29 depicts an example of such an embodiment.

Various types of filters can be utilized to suit particular applications. Such filters may filter air drawn into an HVAC unit, air expelled from such a unit, or both. For instance, active carbon filters may be utilized to reduce and eliminate odors and smell. Filters with various Minimum Efficiency Reporting Value (MERV) levels, such as MERV 4-14, may be utilized to remove the dust particles from air. A high-efficiency particulate air (HEPA) grade pleated filter may be used for center frame portions as characterized herein (see, e.g., 293 of FIG. 29) to capture 99.97% of particles having a size of 0.3 microns or greater. A paper framed active carbon filter may be utilized as a pre filter before such a HEPA filter, which may eliminate volatile organic compounds (VOCs), odors, pet smells, cooking smells, fragrances, smoke and pollution. Different types and grades of filtration may thus be used for the filters, such as pleated filters with active carbon, honeycomb filters, or a carbon mesh.

In addition to the embodiments shown in the figures, various other shapes, sizes and arrangements may be utilized in the context of the present disclosure. For instance, square vents, rectangular vents, round vents, oval vents, or vents of various shapes may be implemented using a similar attachment system and or panel replacement system for customizing filtering.

In accordance with a particular embodiment, an apparatus includes a filter frame having an outer perimeter and operable to hold at least one filter within the outer perimeter, and a fastener configured to selectively couple and decouple the filter frame to an air passageway of an air movement component. The fastener may be engaged with the air movement component (e.g., to louvers of an opening in the air passageway) to apply a force to the filter frame in a direction toward the air movement component, therein forming a sealed air flow channel through the filter frame and one or more filters held within the outer perimeter. In some instances, the apparatus also includes the at least one filter (one or more filters within the outer perimeter).

The filter frame may be provided in one or more of multiple types of arrangements. For instance, the filter frame may include multiple components that engage and disengage with one another, with each component forming a portion of the outer perimeter when engaged. These components maybe similarly sized such that they may be stacked when disengaged for convenient transport. As another example, the filter frame may hold first and second filters within the outer perimeter at respective portions of the filter frame, with the first filter being configured to filter air flowing into the air movement component and the second filter being configured to filter air flowing out of the air movement component.

In another embodiment in which the filter frame includes multiple components, the respective components are configured to slideably engage and disengage with one another, with each component forming a portion of the outer perimeter when engaged. One or more of the multiple components includes a channel, and another one of the multiple components includes a protrusion configured to slide within the channel to engage the respective components with one another. The protrusion and/or channel may include a tab that engages with an opening in the other of the protrusion and/or channel. For instance, the opening and tab may be configured to lock the protrusion into the channel when the respective components are engaged with one another, by depressing/bending as the protrusion is slid into the channel and extending into the opening and locking the components together when the respective components are fully engaged. The tab may further unlock the components from one another for disengagement in response to pressure applied thereto and sliding of the protrusion out of the channel.

In a particular application, the filter frame includes a left end component, a center component, and a right end component. The left end component is configured to engage and disengage with the center component, and the right end component is configured to engage and disengage with the center component. Each component forms a portion of the outer perimeter when the respective left end and right end components are engaged with the center component. The left end, center, and right end components may each have structural aspects configured to hold a filter within the outer perimeter.

The fastener may be implemented in a variety of manners. For instance, the fastener may be configured to selectively couple and decouple the filter frame to the air passageway by engaging with louvers in the opening in an air passageway. The louvers may be utilized to apply the force to seal the perimeter around the opening (e.g., by drawing the outer perimeter toward the louvers). In another instance, the fastener may be operated to selectively couple and decouple the filter frame to the air passageway by engaging with louvers in the opening in an air passageway of an HVAC (heating, ventilating, and air conditioning) unit, and sealing the outer perimeter around an air outlet of the HVAC unit to form the sealed air flow channel. As such, the apparatus can be utilized to filter air expelled by the HVAC unit via the sealed air flow channel. Further, where implemented with multiple filters, the apparatus may filter air flowing into the HVAC unit as well. The apparatus may thus also be decoupled from the HVAC unit for transport, and coupled to another HVAC unit at another location. For instance, the apparatus is portable and may be transferred from HVAC unit to HVAC unit, such as by transferring the apparatus to respective HVAC units in different hotel rooms or other environments.

In certain embodiments, the apparatus includes a cover that includes the filter frame integrated therein. The cover is configured to conform over an underlying cover of the air movement component with the outer perimeter of the frame lying within an outer perimeter of the cover and with the outer perimeter sealed around the opening in the air passageway. Such an application may be useful, for example, to cover old or unsightly HVAC units, and to further provide enhanced filtration of air provided thereby.

In another embodiment in which the filter frame includes multiple components, the components are configured to engage and disengage with one another and each of the multiple components forms a portion of the outer perimeter when engaged. The components may have a length and height that respectively have values that are within 10% of length and height values of another one of the multiple components, facilitating stacking of the components for transport when disengaged.

In a particular embodiment, the at least one filter includes first and second filters and the filter frame includes first and second regions. The first region holds the first filter and is configured to form a seal around a first opening in the air passageway via which air flows into the air movement component, therein forcing air flowing into the air movement component to pass through the first filter. The second region holds the second filter and is configured to form a seal around a second opening in the air passageway via which are is expelled from the air movement component, therein forcing air expelled from air movement component to pass through the second filter.

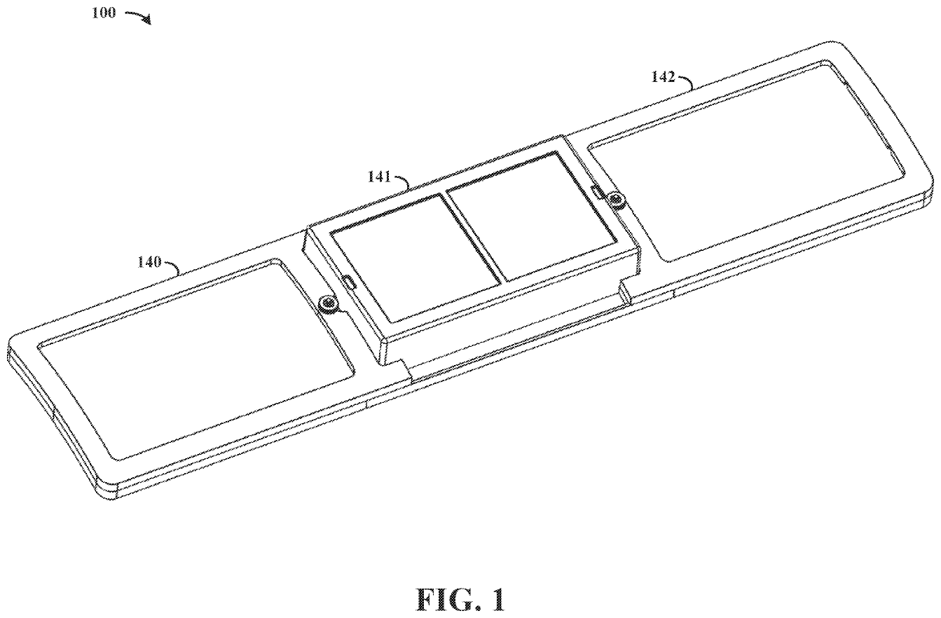

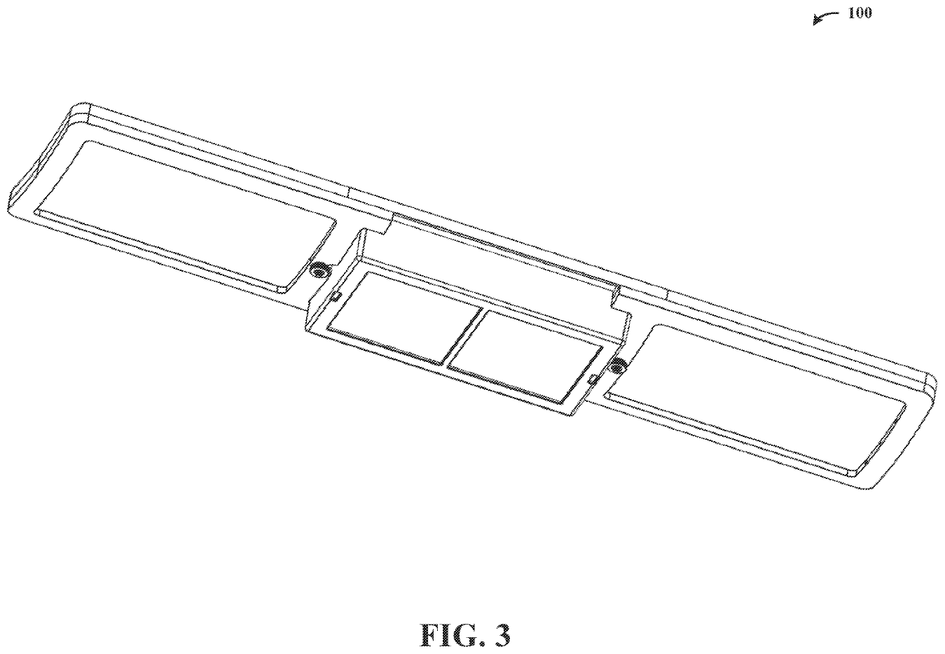

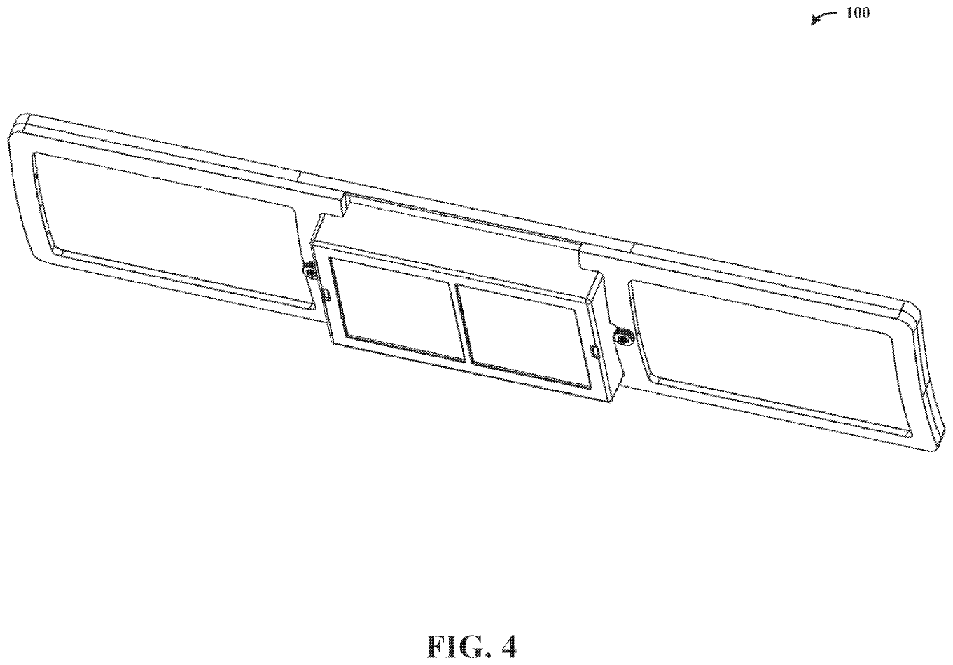

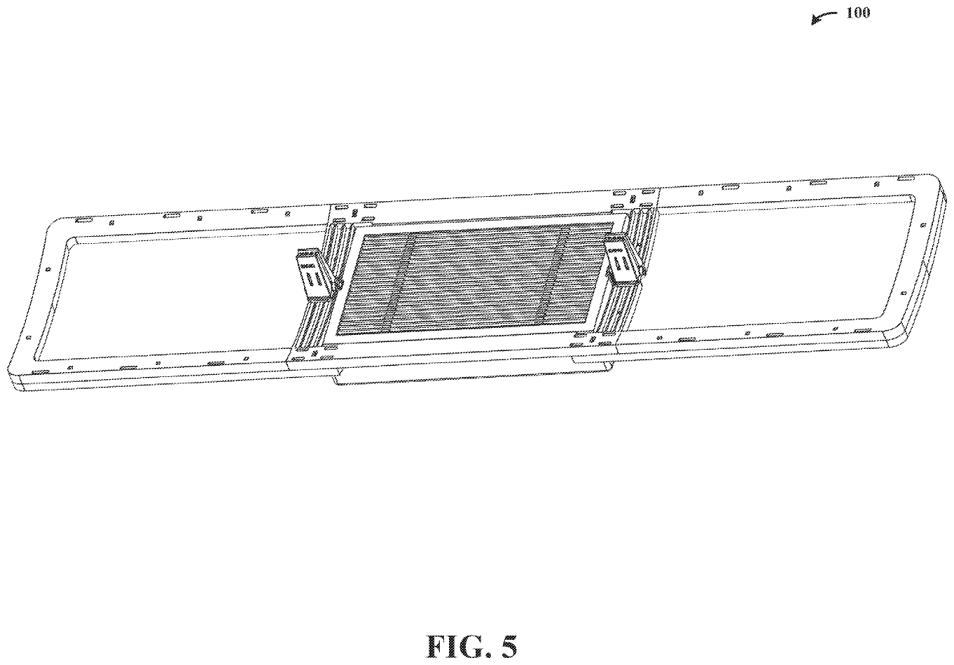

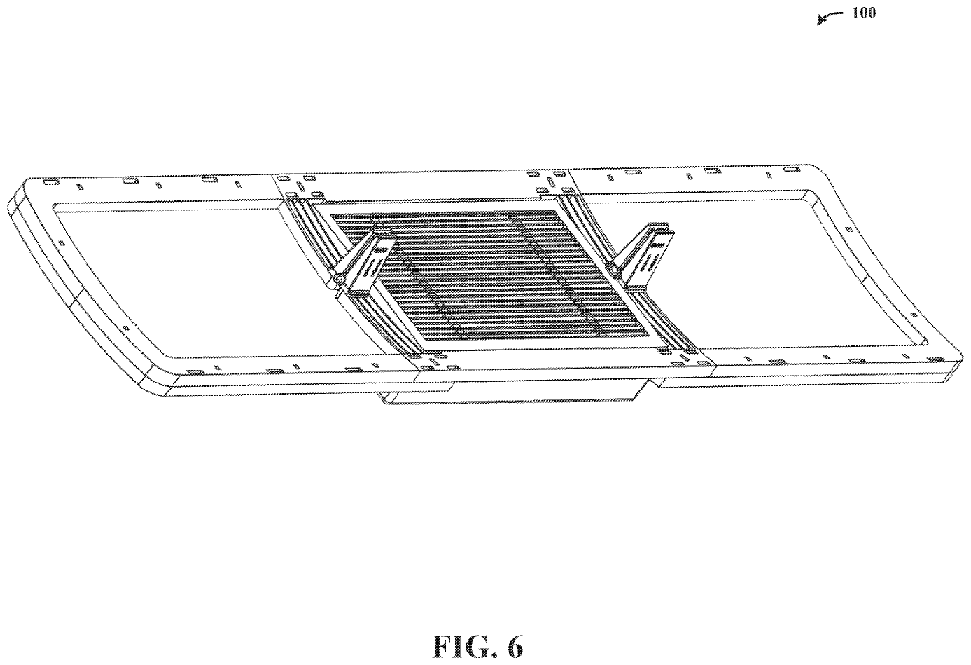

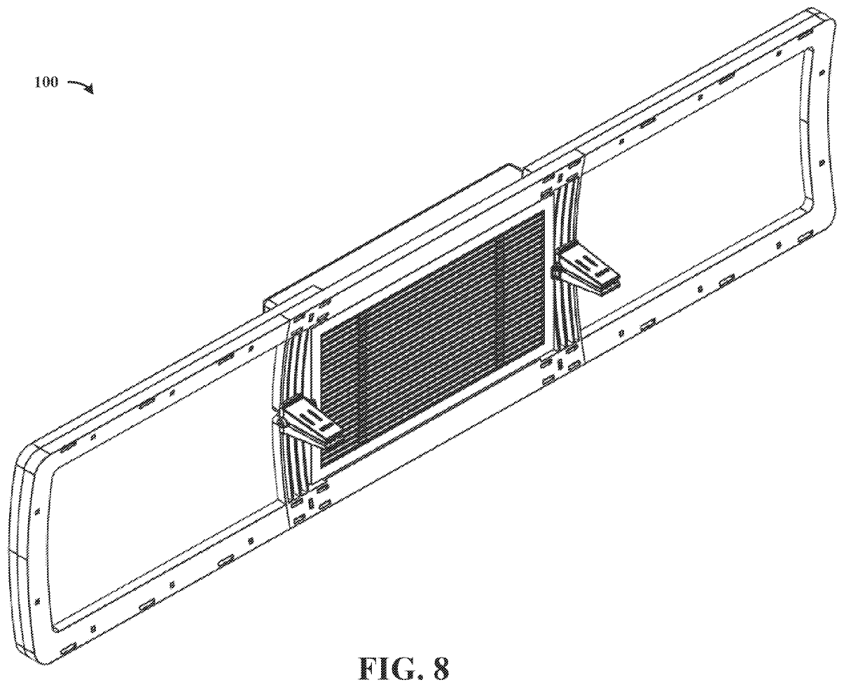

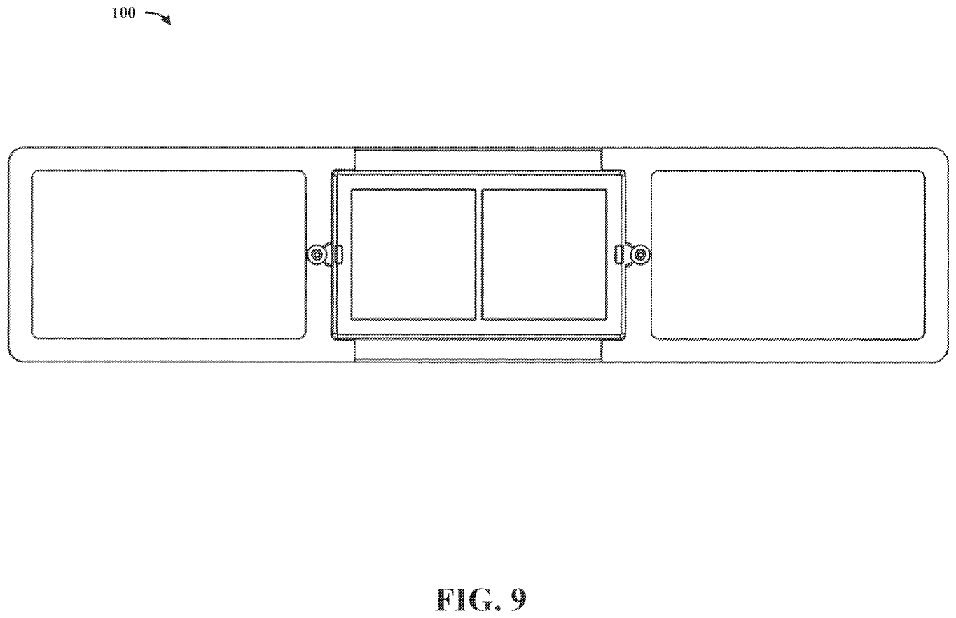

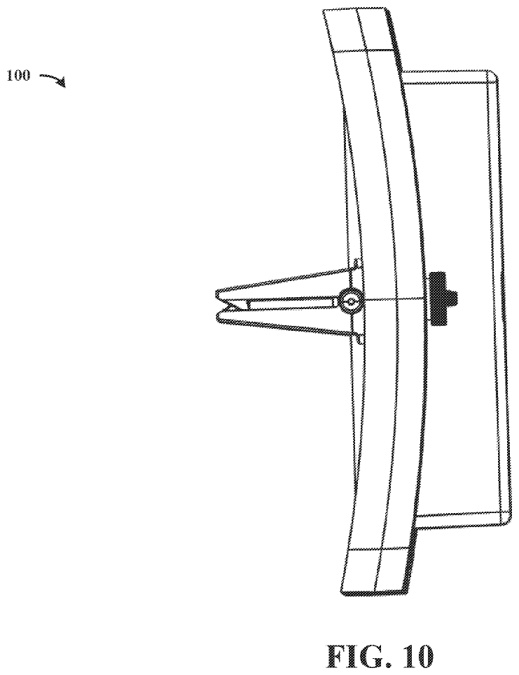

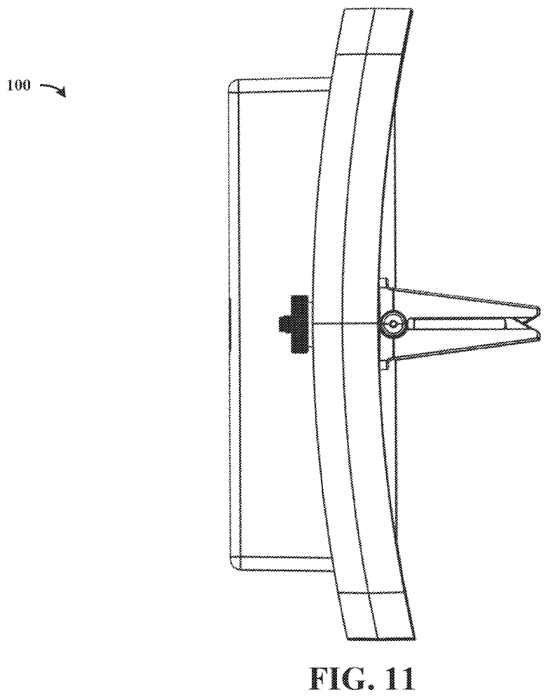

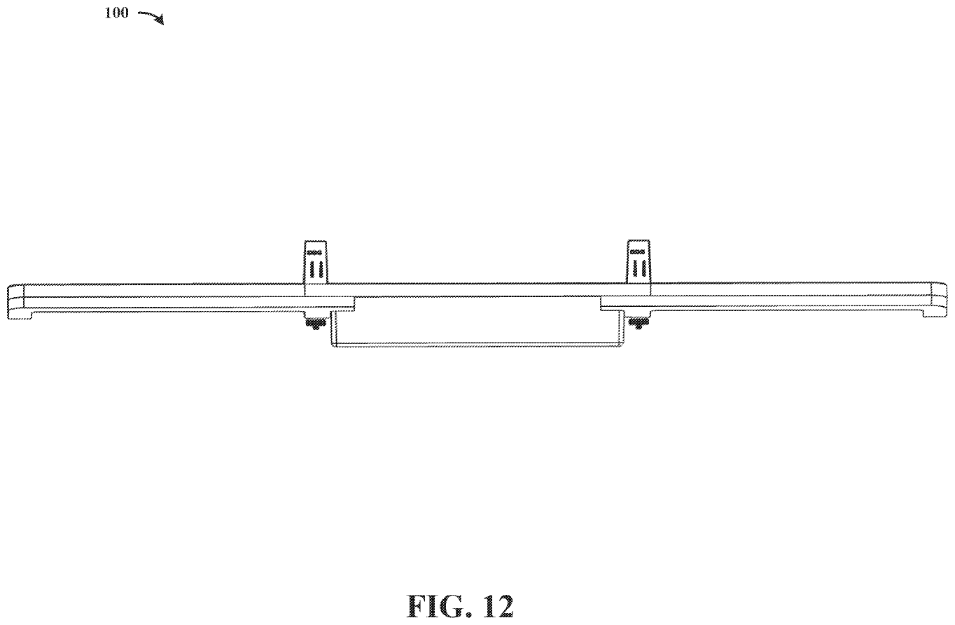

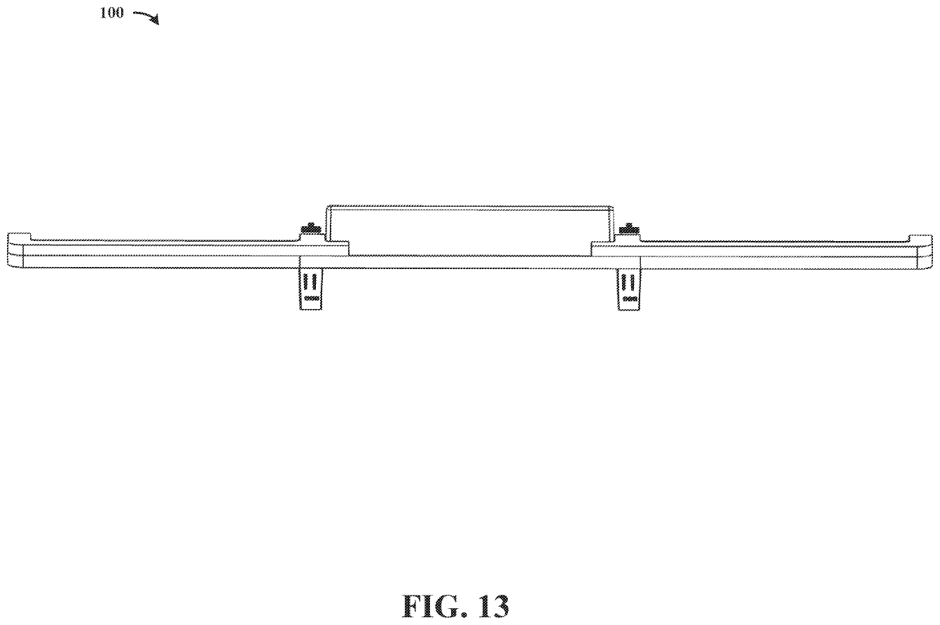

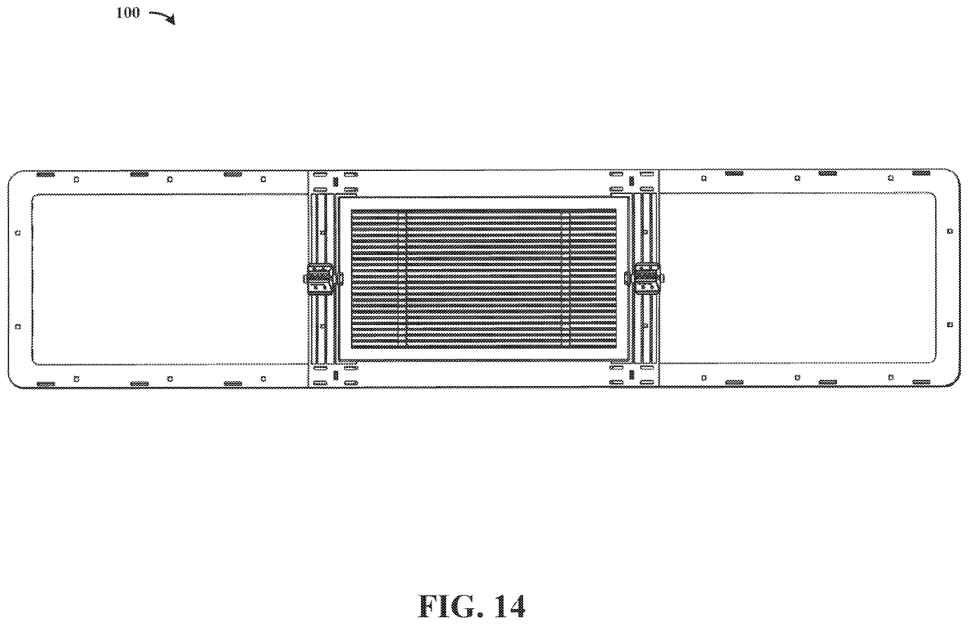

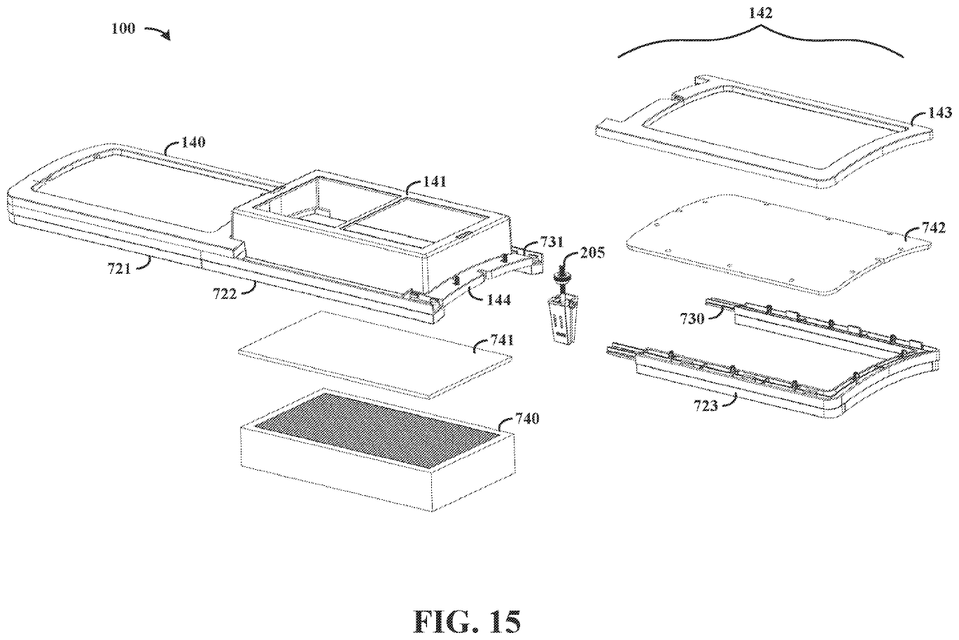

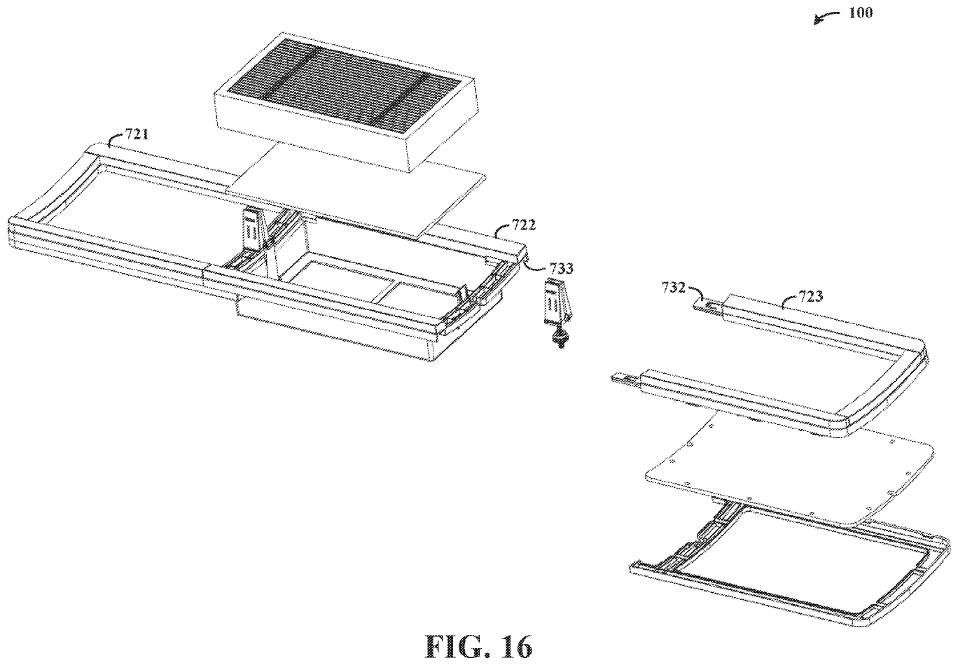

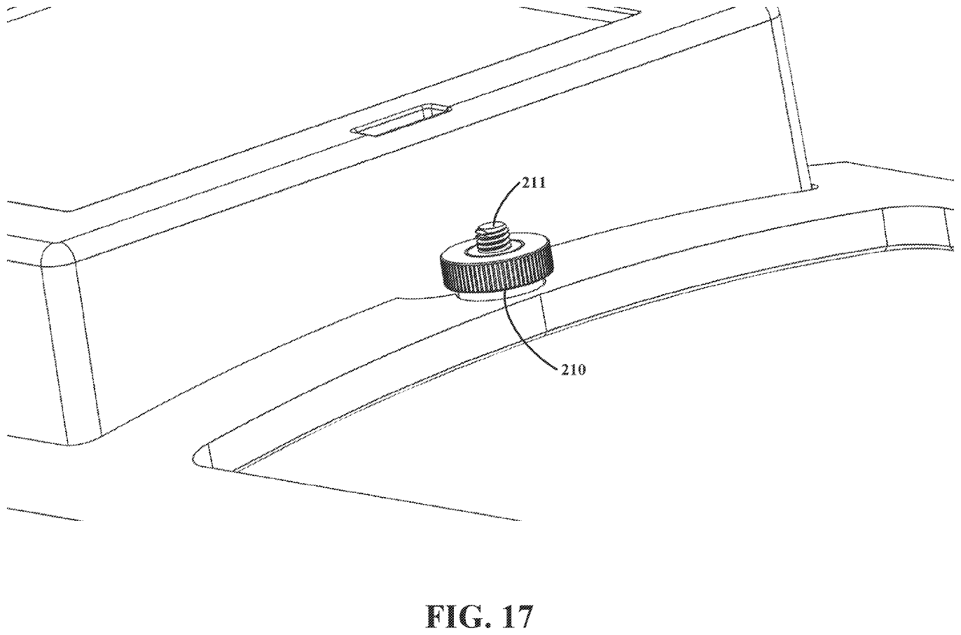

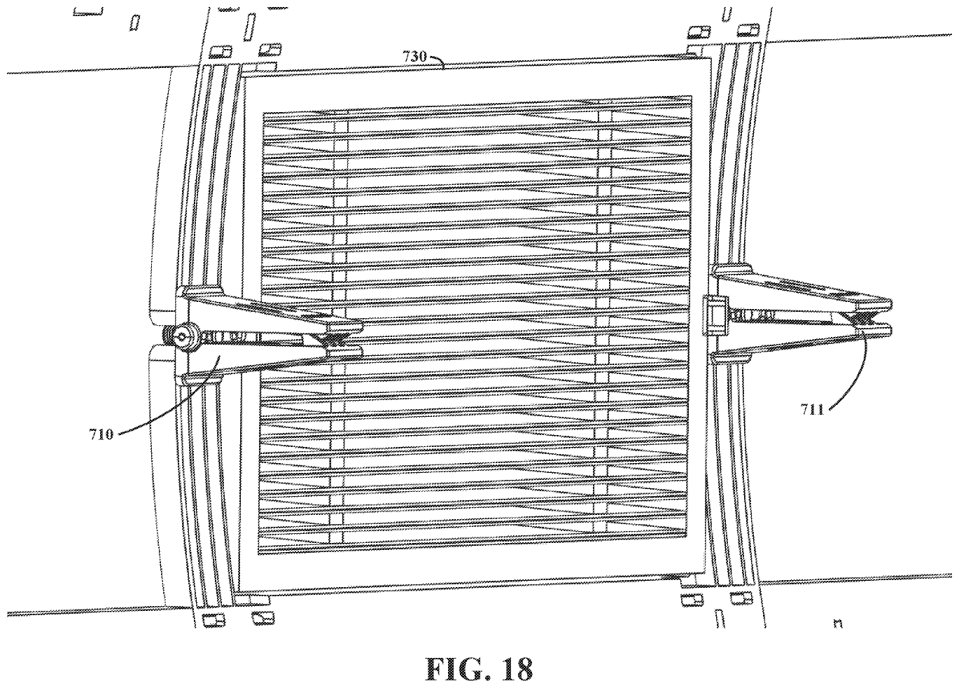

Turning now to the figures, FIGS. 1-4 show front perspective views of a filter apparatus 100, and FIGS. 5-8 show rear perspective views of the filter apparatus, a may be implemented in accordance with one or more embodiments. FIGS. 9-14 show front, left, right, top, bottom and rear views the filter apparatus, and FIGS. 15-16 show exploded top and bottom views of the filter apparatus. FIG. 17 shows a front perspective view of a front portion of the filter apparatus, and FIG. 18 shows a rear perspective view of a rear portion of the filter apparatus.

The filter apparatus 100 may include left end portion 140, center portion 141, and right end portion 142, which may be detachable. Each portion may be operable to utilize one or more filters. When detached, for instance may be implemented by removing end portions as depicted in FIGS. 15 and 16, the respective left, center and right portions 140-142 may be stacked and combined for transport. When coupled, the portions 140-142 form an outer perimeter of the filter apparatus 100 (e.g., rectangular-shaped near outer edges thereof)

Referring specifically to FIG. 15, the center portion 141 may be utilized to hold filters 740, 741, or both. For instance, filter 740 may be a pleated filter operable for particulate filtering. Filter 741 may be a carbon-based filter to eliminate odors. End portions 140 and 142 may similarly hold filters, such as filter 742 depicted in FIG. 15. Such a filter 742 may be coupled by removing a top portion 143. In other embodiments, the end portion 142 may include a channel such that filter 742 may slide into the end portion, for instance in a manner similar to that depicted in FIG. 29 and described below.

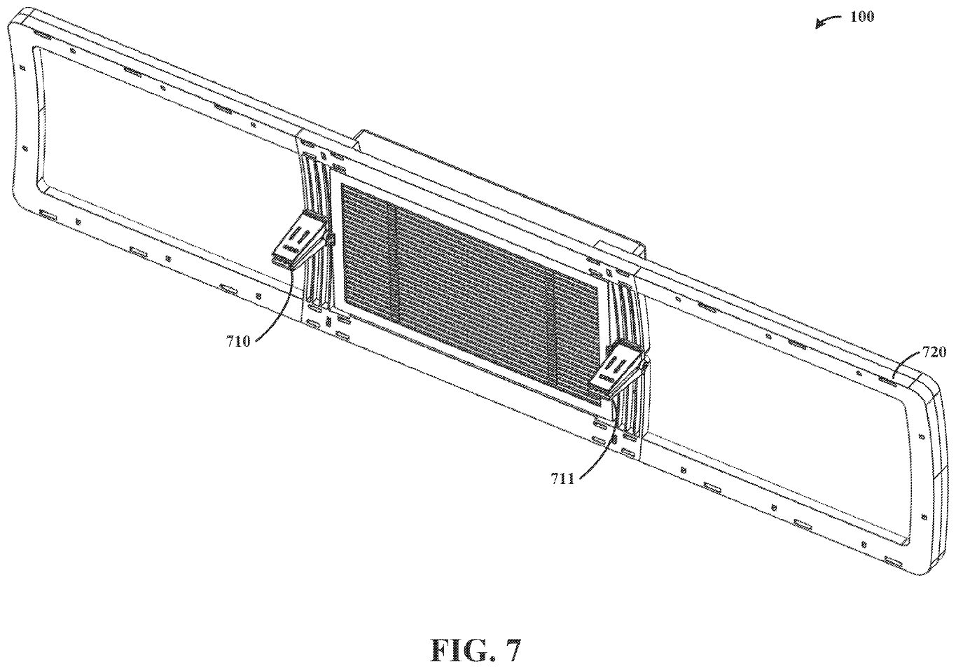

Referring to the rear views and particularly to FIGS. 7, 15, 16, 18 and 20, fasteners 205 include 710 and 711 as shown and may be utilized to couple to vents or louvers of HVAC type equipment. Portion 720 may include an elastic or otherwise flexible material, such as a foam or memory foam (e.g., ⅝″ foam), around the perimeter of the frame and operable for sealing to the HVAC type equipment, around the vents or louvers. In certain implementations, additional elastic or flexible material 721 and 722 may be applied to the frame as shown in exploded views in FIGS. 15 and 16. A filter 730 may be situated between the clamps as shown. Dual clamps may be utilized to enhance coupling to vents or louvers.

Where two or more of the left, center and right portions 140-142 have filters, a further seal may be provided to seal respective air passageways for air passing through each filter (separately). For instance, a seal may be provided at an interface 144 between the right end portion 142 and the center portion 141, for instance by using a foam similar to the material 721 and across a the backside of the apparatus to connect upper and lower portions of the perimeter along which material 721 may reside, thus forming a seal.

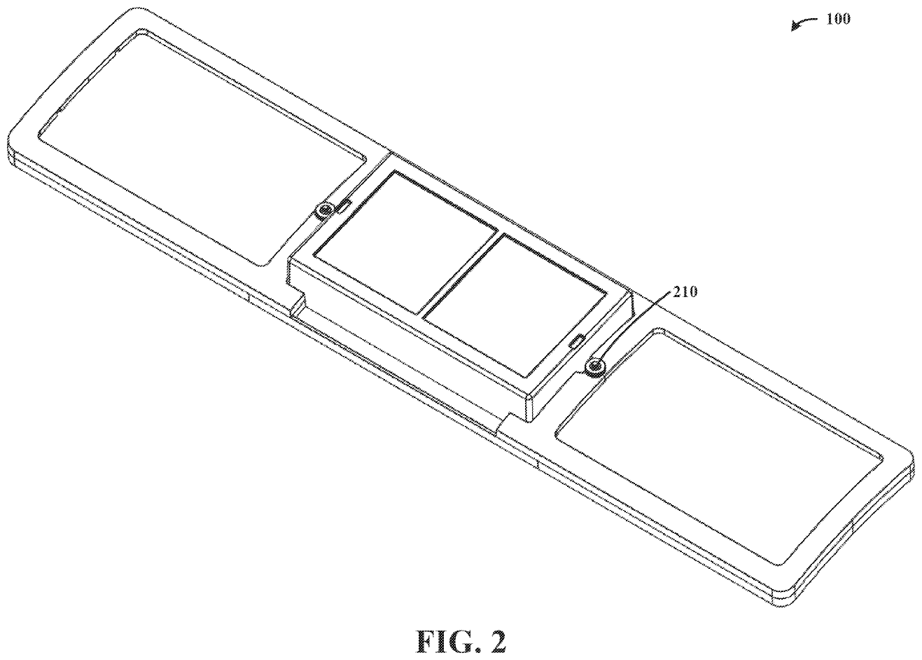

Referring to the front views and particularly to FIGS. 2, 15, 17 and 20, a knob 210 and threaded core 211 are components of the fastener 205 that secure the filter frame to the HVAC type equipment, with the knob operable with the clamps for securing and forming a seal around the perimeter of the filter apparatus.

As noted above, a variety of filters and filter types may be utilized. FIG. 19 shows an exploded view of a portion of the filter apparatus and filters 1910 and 1920, as may be implemented with respective embodiments. For instance, filter 1910 may be a HEPA type filter and filter 1920 may be an active carbon filter. These filters may be used with the apparatus separately or together.

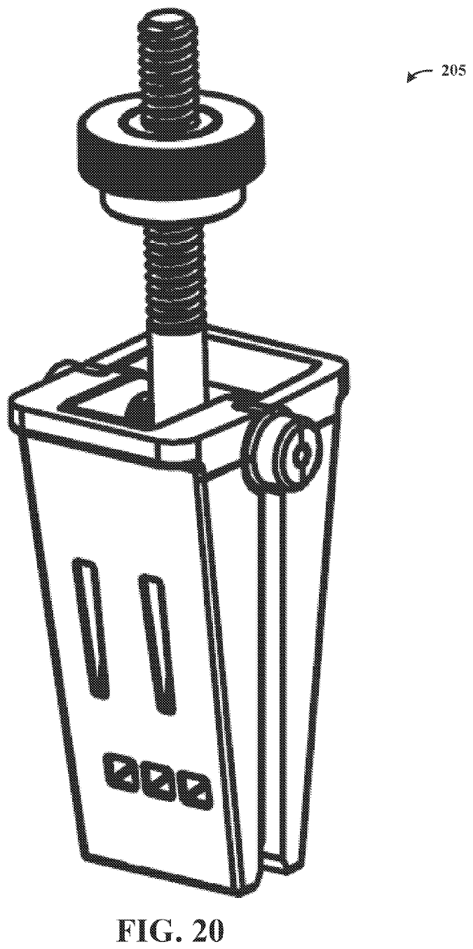

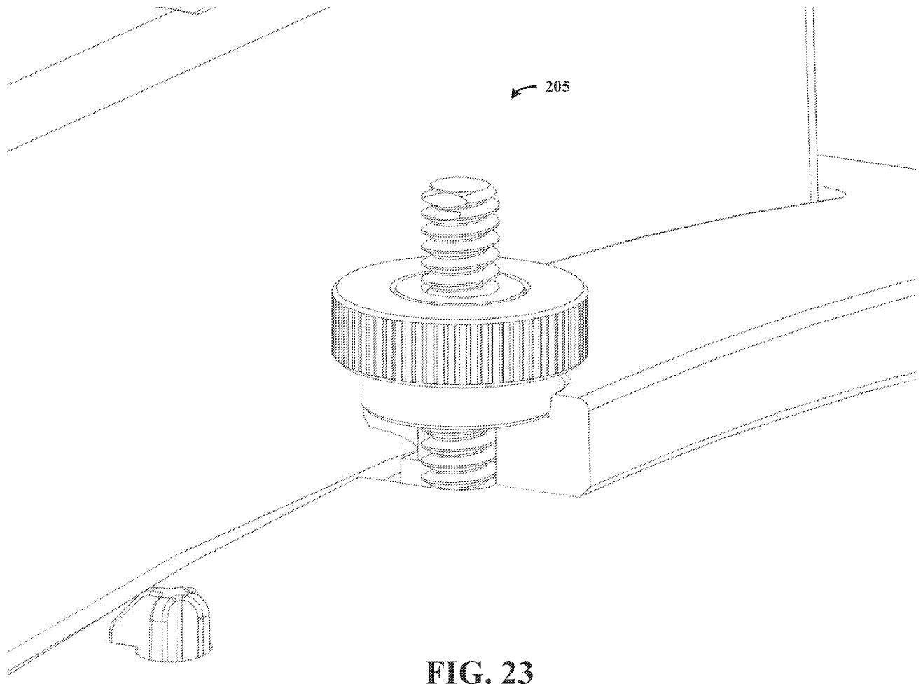

FIG. 20 shows a perspective view of a fastener 205, and FIG. 23 shows a perspective view of an implementation of the fastener coupled to a filter apparatus, as may be utilized with the filter apparatus of FIG. 1.

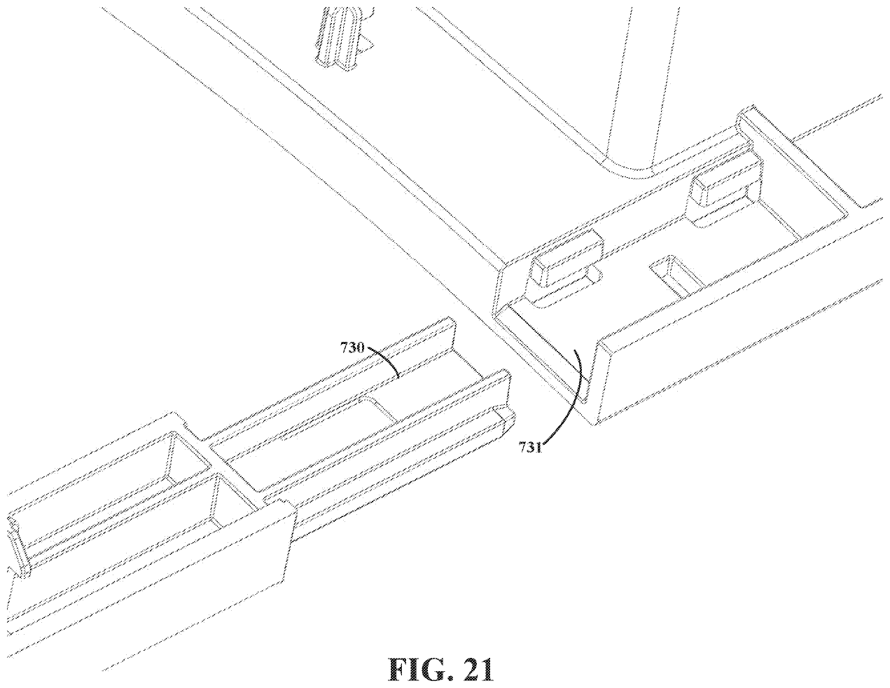

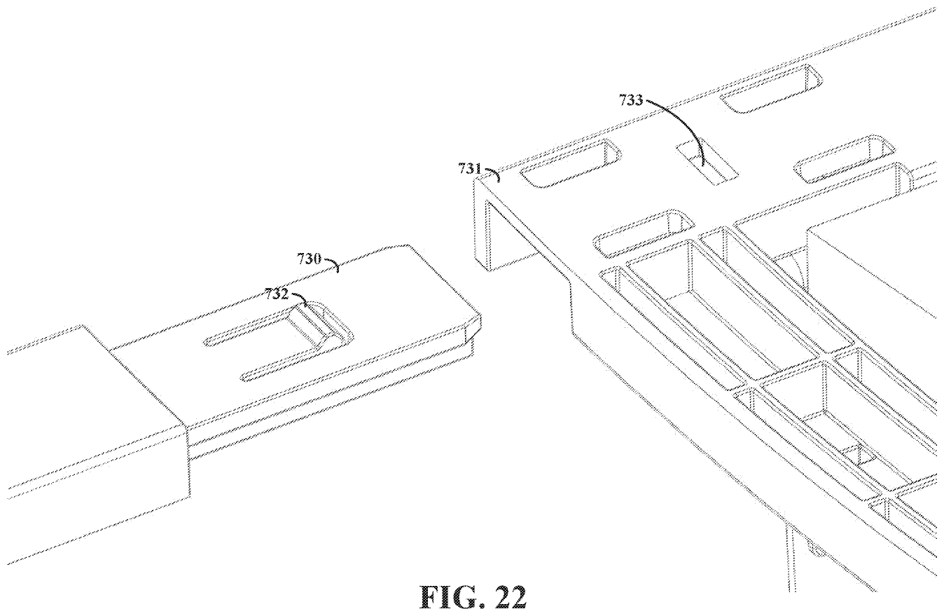

Referring to the front-side exploded view in FIG. 15 and further to FIG. 21, engagement componentry 730 and 731 may be utilized for coupling and disassembling portions of the filter apparatus as shown. For instance, component 730 may slide into a channel region at 731 as shown in FIG. 21. Referring to the back-side exploded view in FIG. 16 and further to FIG. 22, the shown engagement componentry may be used for coupling respective portions of a filter apparatus, such as may be implemented with the filter apparatus of FIG. 1, for instance with a tab 732 operable for locking into position at opening 733. When locked in position, depressing tab 732 may allow the respective components to release from one another.

FIG. 24 shows a perspective view of an implementation of a filter apparatus 10, such as that depicted in FIG. 1 and/or one or more of the other figures, coupled to an HVAC unit 20 in accordance with one or more embodiments. Where implemented with the filter apparatus shown in the Figures, clamps such as shown in FIG. 7 may be utilized to clamp onto louvers of the HVAC unit 20, and knobs such as knob 210 can be utilized to seal the filter apparatus 10 around the louvers. This approach may facilitate particulate and/or odor/gas elimination in an environment served by the HVAC unit 20.

In some embodiments, the filter apparatus 10 includes a filter frame having an outer perimeter (around apparatus 10) that seals around an air passageway of HVAC unit 20 (an air movement component). Fasteners may be engaged with the HVAC unit (e.g., to louvers of an opening in an air passageway thereof) to apply a force to the filter frame in a direction toward the air movement component, therein forming a sealed air flow channel through the filter frame and one or more filters held within the outer perimeter.

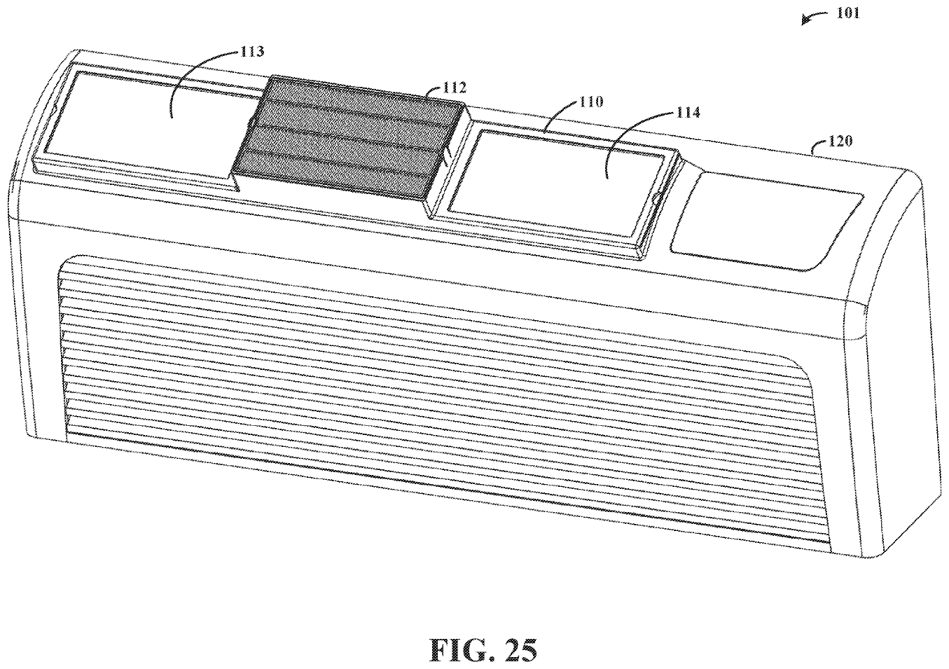

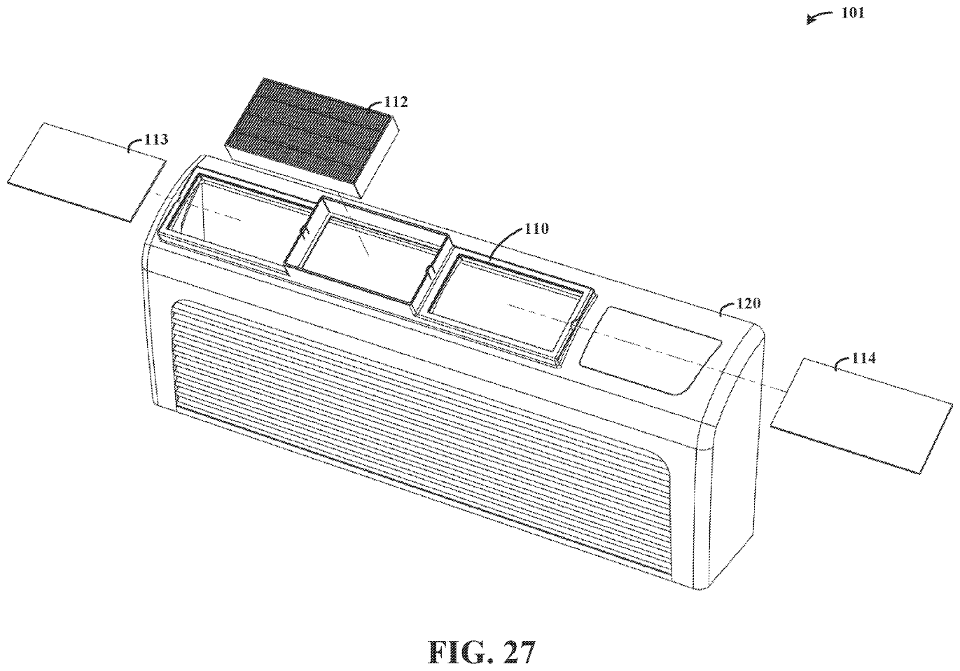

FIGS. 25-27 respectively show top/front, underside/rear and exploded views of an apparatus 101, operable as a replacement cover and/or an over-cover for an HVAC unit, as may be implemented in accordance with one or more embodiments. The apparatus includes a filter component 110 and a cover 120. The filter component 110 has a central filter 112 and side filters 113 and 114, which may be respectively coupled to left, center and right portions as shown (e.g., as may be implemented similarly to 140, 141 and 142 as depicted in FIG. 1 and/or the apparatus shown in FIG. 29). Referring to FIG. 27, filters 112, 113 and 114 may be replaceable as shown.

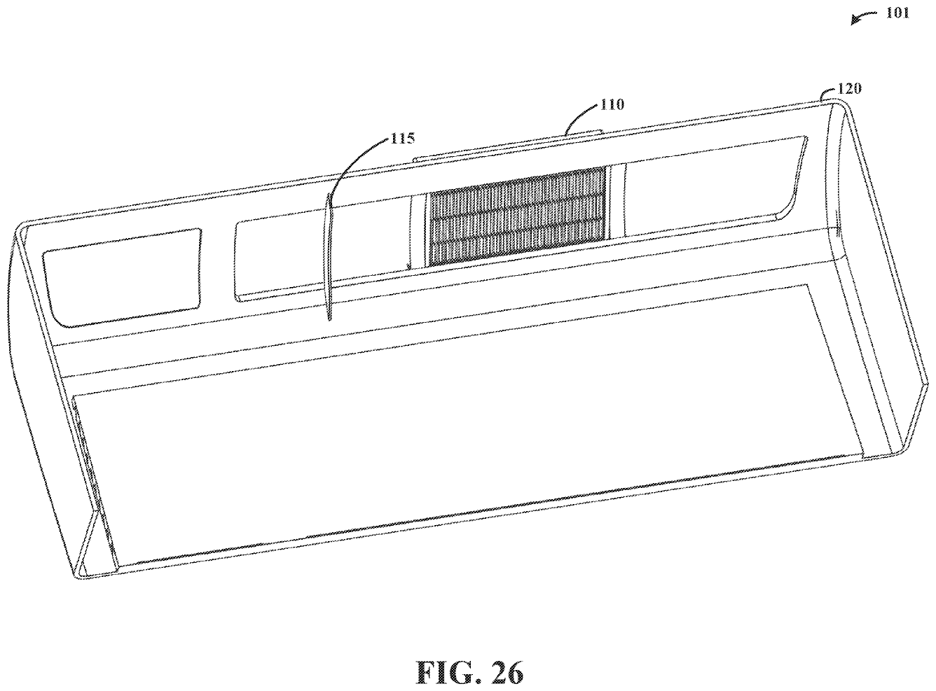

The cover 120 may be operable for replacing a cover on an HVAC unit, or for placement over an existing cover of such an HVAC unit. Referring to FIG. 26, the underside may include spacers such as spacer 115, which may facilitate fitment of the cover to specific HVAC units.

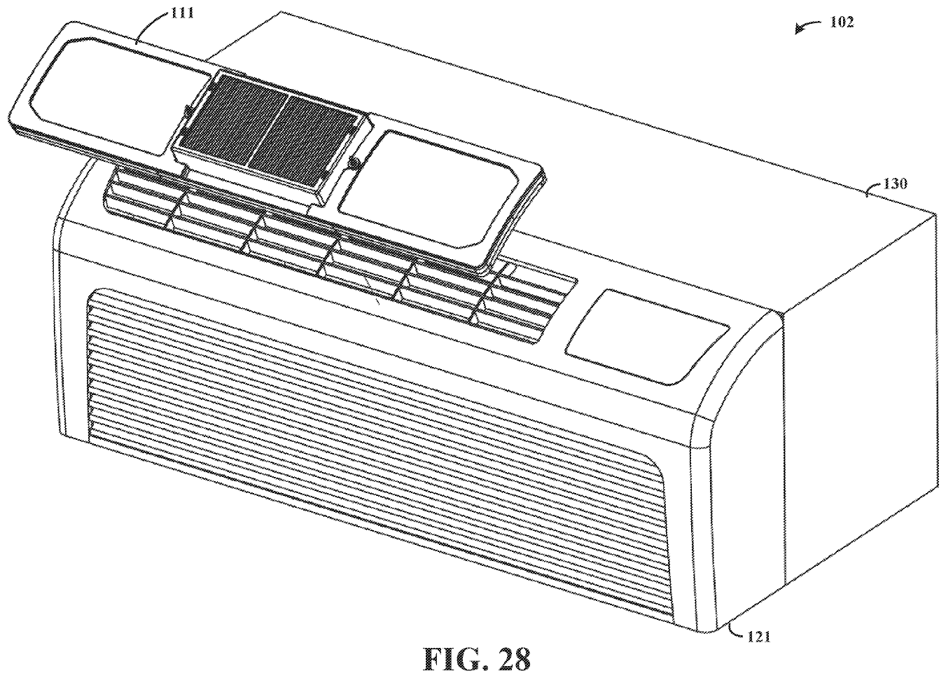

FIG. 28 shows an apparatus 102, including a cover 121 having a filter component 111 (shown detached), as may be implemented in accordance with one or more embodiments herein. The cover 121 is shown coupled to an HVAC unit 130. The filter component 111 may be integrated within the cover 121, for instance in a manner similar to that shown in FIGS. 25-27. The filter component 111 may alternatively be implemented in accordance with the apparatus shown in FIGS. 1-23, or in FIG. 29.

FIG. 29 shows an HVAC filter apparatus 290, in accordance with another embodiment. The apparatus 290 is depicted with a left end portion 291, a center portion 292, and a right end portion 293. The respective end portions may be configured to receive slide-in portions 294 as shown, which may be filters or may be a solid material to prevent the flow of air. The center portion 293 may be configured to accept one or both of filter media 295, such as a pleated particulate filter, and filter media 296, such as a carbon filter. The end portions (as may also be referred to as side frames) may be utilized with filters having different thickness and/or composition (e.g., carbon filters for odor reduction, or particulate filters operable to filter/pass particulates of different sizes).

One or more fasteners may be utilized with the apparatus 290 to fasten the apparatus to an HVAC device. By way of example, fastener 297 may be implemented in a manner similar to that depicted with fastener 205 as depicted in FIG. 20, and as further shown with various other figures herein (see, e.g., FIG. 18). A carrying case 298 may be provided to house and carry the components 291-297. The carrying case 298 may be coupled to luggage or other componentry by a further fastener, such as carabineer 299.

The perimeter of the filter apparatus 290 may include foam or other sealant type material, that facilitates sealing of the apparatus 290 to an HVAC unit, for example in a manner similar to that depicted in FIG. 28 (with 111 sealed to 130). This may be effected using one or more fasteners 297, which may be coupled to louvers of the HVAC unit and tightened thereto (e.g., using a knob 210 as shown in FIG. 17).

Based upon the above discussion and illustrations, those skilled in the art will readily recognize that various modifications and changes may be made to the various embodiments without strictly following the exemplary embodiments and applications illustrated and described herein. For example, different shapes and sizes of filter frames and filters may be utilized. Such modifications do not depart from the true spirit and scope of various aspects of the invention, including aspects set forth in the claims.

What is claimed is:

1. An apparatus comprising:
a filter frame having an outer perimeter and configured to hold at least one filter within the outer perimeter; and
a fastener configured to selectively couple and decouple the filter frame to an air passageway of an air movement component, and to seal the outer perimeter around an opening in the air passageway via which air may flow by engaging with the air passageway to apply a force to the filter frame in a direction toward the air movement component, therein forming a sealed air flow channel through the filter frame and the at least one filter held within the outer perimeter.

2. The apparatus of claim 1, wherein the filter frame includes multiple components configured to engage and disengage with one another, with each component forming a portion of the outer perimeter when engaged.

3. The apparatus of claim 1, wherein the filter frame includes a left end component, a center component, and a right end component, the left end component being configured to engage and disengage with the center component, the right end component being configured to engage and disengage with the center component, with each component forming a portion of the outer perimeter when the respective left end and right end components are engaged with the center component.

4. The apparatus of claim 3, wherein the left end, center, and right end components each have structural aspects configured to hold a filter within the outer perimeter.

5. The apparatus of claim 1, wherein the fastener is configured to selectively couple and decouple the filter frame to the air passageway by engaging with louvers in the opening in an air passageway and utilizing the louvers to apply the force to seal the perimeter around the opening.

6. The apparatus of claim 1, wherein the fastener is configured to selectively couple and decouple the filter frame to the air passageway by engaging with louvers in the opening in an air passageway of an HVAC (heating, ventilating, and air conditioning) unit, including sealing the outer perimeter around an air outlet of the HVAC unit to form the sealed air flow channel, and filtering air expelled by the HVAC unit via the sealed air flow channel.

7. The apparatus of claim 1, further including a cover that includes the filter frame, the cover being configured to conform over an underlying cover of the air movement component with the outer perimeter of the frame lying within an outer perimeter of the cover and with the outer perimeter sealed around the opening in the air passageway.

8. The apparatus of claim 1, wherein the filter frame includes multiple components configured to slideably engage and disengage with one another, with each component forming a portion of the outer perimeter when engaged.

9. The apparatus of claim 8, wherein at least one of the multiple components includes a channel and wherein at least another one of the multiple components includes a protrusion configured to slide within the channel to engage the respective components with one another.

10. The apparatus of claim 9, wherein:
one of the protrusion and the channel includes a tab; and
the other one of the protrusion and the channel includes an opening, the opening and tab being configured to lock the protrusion into the channel when the respective components are engaged with one another, by depressing as the protrusion is slid into the channel and by extending into the opening and locking the components together when the respective components are fully engaged.

11. The apparatus of claim 10, wherein the tab is configured to unlock the components from one another for disengagement in response to pressure applied thereto and sliding of the protrusion out of the channel.

12. The apparatus of claim 1, wherein:
the filter frame includes multiple components configured to engage and disengage with one another;
each of the multiple components forms a portion of the outer perimeter when engaged; and
each of the multiple components has a length and height that respectively have values that are within 10% of length and height values of another one of the multiple components, therein facilitating stacking of the components for transport when disengaged.

13. The apparatus of claim 1, further including the at least one filter, the at least one filter being configured to filter air flowing through the sealed air flow channel.

14. The apparatus of claim 1, wherein the filter frame is configured to hold first and second filters within the outer perimeter at respective portions of the filter frame, the first filter being configured to filter air flowing into the air movement component and the second filter being configured to filter air flowing out of the air movement component.

15. The apparatus of claim 1, wherein:
the at least one filter includes first and second filters; and
the filter frame includes first and second regions in which:
the first region holds the first filter and is configured to form a seal around a first opening in the air passageway via which air flows into the air movement component, therein forcing air flowing into the air movement component to pass through the first filter, and
the second region holds the second filter and is configured to form a seal around a second opening in the air passageway via which are is expelled from the air movement component, therein forcing air expelled from air movement component to pass through the second filter.
